(19) United States
(12) Patent Application Publication
(10) Pub. No.: US 2025/0115340 A1
(43) Pub. Date: Apr. 10, 2025

(54) LIFT SYSTEMS AND METHODS FOR LAUNCHING AND RECOVERING STRUCTURES IN A MARINE ENVIRONMENT

(71) Applicant: BARDEX CORPORATION, Goleta, CA (US)

(72) Inventor: Robert Taylor, Santa Barbara, CA (US)

(73) Assignee: BARDEX CORPORATION, Goleta, CA (US)

(21) Appl. No.: 18/898,114

(22) Filed: Sep. 26, 2024

Related U.S. Application Data
(60) Provisional application No. 63/585,451, filed on Sep. 26, 2023.

(51) Int. Cl. B63B 77/10; B63B 35/00; B63B 35/40; B63B 35/42; B63B 35/44

(52) U.S. Cl. CPC B63B 77/10; B63B 35/003; B63B 35/42; B63B 2035/405; B63B 2035/446

(57) ABSTRACT

Systems and methods for assembling, launching, retrieving, and maintaining floating wind foundations including tower, nacelle, and blades with two-way operability are disclosed. The systems include a dock having a lift platform and a first plurality of chain jacks configured to lift and lower the lift platform. The lift platform has a width and length with a span sufficient to receive, lower, and lift a floating wind foundation. The lift platform includes an upper deck and a plurality of box truss girders supporting the upper deck. The box truss girders extend across the span of the width of the lift platform and are of sufficient strength to support a floating wind foundation.

### CROSS-REFERENCE TO RELATED APPLICATIONS

The present application claims the benefit of U.S. Provisional Patent Application No. 63/585,451 (pending), filed on Sep. 26, 2023, and entitled “LIFT SYSTEMS AND METHODS FOR LAUNCHING AND RECOVERING STRUCTURES IN A MARINE ENVIRONMENT”, the entirety of which is incorporated herein by reference.

### FIELD

The present disclosure relates to systems and methods for launching and recovering structures in a marine environment.

### BACKGROUND

The offshore wind farm market faces challenges in optimizing supply chain to ensure timely project execution, cost-effectiveness, and minimal environmental impact. For example, the assembly, deployment, ongoing maintenance, and replacement of components of an offshore wind farm suffer from supply chain issues, including the availability and proximity of equipment capable of lifting offshore wind farm components. While some technologies exist for the launch of floating wind foundations, existing technologies are not capable of a rate of launch and recovery of floating wind foundations that is sufficient to achieve a timely transition to offshore wind generation in view of global climate concerns.

Shiplifts are used to deploy ships. Such lifts do not exceed 35 meters in span, as they are designed to handle vessels that are much longer than they are wide. Also, shiplifts include a platform supported on plate girders, which are suitable for use at spans only up to about 40 meters, and only under moderate loading conditions. These limitations render existing shiplifts incapable of launching and recovering fully assembled floating wind foundations.

The ability to streamline the assembly, deployment, maintenance, and replacement of offshore wind farm components is an important element in the transition of the global energy supply from land-based fossil fuels to offshore wind generation. There is need for technologies capable of launch and recovery of floating wind foundations or other large and heavy marine structures.

### BRIEF SUMMARY

The present disclosure includes a lift system for launch and recovery of marine equipment. The lift system includes a lift platform having a width and length of at least sixty meters. The lift platform includes an upper deck supported by a plurality of girders. The lift system includes a plurality of lifts coupled with the lift platform and configured to raise and lower the lift platform.

The present disclosure includes a method of deploying and retrieving marine equipment. The method includes positioning marine equipment on a lift platform that has a width and length of at least sixty meters and an upper deck that is supported by a plurality of girders. The method includes raising the lift platform with a plurality of lifts to retrieve the marine equipment, or lowering the lift platform with the plurality of lifts to deploy the marine equipment.

The present disclosure includes a floating dock for deploying and retrieving marine equipment. The floating dock includes a dock, a plurality of lifts on the dock, and a lift platform positioned adjacent the dock. The lift platform has a width and length of at least sixty meters and an upper deck that is supported by a plurality of girders. The lifts are coupled with the lift platform and configured to raise and lower the lift platform relative to the dock.

The present disclosure includes a wind farm system. The system includes a wind farm positioned at a first offshore site and including a plurality of offshore wind turbines. The system includes a floating dock moored at a second offshore site. The second offshore site is in close proximity to the first offshore site. The system includes a plurality of lifts on the floating dock, and a lift platform positioned adjacent the floating dock. The lift platform has a width and length of at least sixty meters and an upper deck that is supported by a plurality of girders. The lifts are coupled with the lift platform and configured to raise and lower the lift platform relative to the floating dock.

The present disclosure includes a method of assembling, maintaining, and decommissioning a wind farm. The method includes mooring a floating dock at a first offshore site. The method includes assembling an offshore wind turbine or components thereof on the floating dock. The method includes deploying the offshore wind turbine or components thereof into water at the first offshore site. The deploying includes positioning the offshore wind turbine or components thereof on a lift platform of the floating dock and lowering the lift platform into the water. The method includes transporting the offshore wind turbine or components thereof from the first offshore site to a second offshore site and installing the offshore wind turbine or components thereof at the second offshore site to form a wind farm at the second offshore site.

The present disclosure includes a system for launching and retrieving floating wind foundations. The system includes a dock at least partially defining a space, and lift platform positioned at least partially within the space. The lift platform has a width in a lateral direction and a length in a longitudinal direction. The system includes a first plurality of chain jacks positioned on the dock along and adjacent a first longitudinal side of the lift platform, and a second plurality of chain jacks positioned on the dock along and adjacent a second longitudinal side of the lift platform. Each of the chain jacks is coupled with the dock and the lift platform, and the chain jacks are configured to move the lift platform between a first height of the lift platform and a second height of the lift platform. At the first height, the lift platform is above a water level and, at the second height, the lift platform is below the water level. The width of the lift platform has a span of from 60 to 120 meters and the length of the lift platform has a span of from 60 to 120 meters. The lift platform includes an upper deck and a plurality of box truss girders supporting the upper deck. The box truss girders extend across the span of the width of the lift platform.

The present disclosure includes a lift system for launching and retrieving floating wind foundations. The lift system includes a lift platform having a width in a lateral direction and a length in a longitudinal direction. The width of the lift platform has a span of from 60 to 120 meters and the length of the lift platform has a span of from 60 to 120 meters. The lift platform has an upper deck and a plurality of box truss girders supporting the upper deck. The box truss girders extend across the span of the width of the lift platform. The lift system includes a first plurality of chain jacks coupled with a first longitudinal side of the lift platform, and a second plurality of chain jacks coupled with a second longitudinal side of the lift platform. The chain jacks are configured to lift and lower the lift platform.

The present disclosure includes a method for assembling, launching, retrieving, and repairing floating wind foundations. The method includes assembling a floating wind foundation in an assembly of a dock, moving the floating wind foundation from the assembly area to a lift platform of the dock, lowering the lift platform until the floating wind foundation is positioned in water adjacent the dock, and towing the floating wind foundation from the dock to a site.

### BRIEF DESCRIPTION OF THE DRAWINGS

So that the manner in which the features and advantages of the systems and methods of the present disclosure may be understood in more detail, a more particular description briefly summarized above may be had by reference to the embodiments thereof which are illustrated in the appended drawings that form a part of this specification.

FIG. 1 depicts a floating dock having a lift system in accordance with embodiments of the present disclosure.

FIG. 2 depicts a foundation for a wind turbine being transported on a floating dock toward a lift system in accordance with embodiments of the present disclosure.

FIG. 3 depicts a foundation for a wind turbine positioned on a lift system in accordance with embodiments of the present disclosure.

FIG. 4 depicts a foundation for a wind turbine being deployed into the water by a lift system in accordance with embodiments of the present disclosure.

FIG. 5 depicts a wind farm in accordance with embodiments of the present disclosure.

FIG. 6 depicts a wind turbine being towed toward a floating dock in accordance with embodiments of the present disclosure.

FIG. 7 depicts a wind turbine being lifted by a lift system onto a floating dock in accordance with embodiments of the present disclosure.

FIG. 8 depicts a wind turbine after being lifted by a lift system onto a floating dock in accordance with embodiments of the present disclosure.

FIG. 9A depicts a lift system of a floating dock in accordance with embodiments of the present disclosure.

FIG. 9B is a detail view of FIG. 9A showing a chain jack of the lift system.

FIG. 10A is a top view of a lift system of a floating dock in accordance with embodiments of the present disclosure.

FIG. 10B is a front view of a lift system of a floating dock in accordance with embodiments of the present disclosure.

FIG. 10C is a detail view showing how a chain jack connects with a lift platform of a lift system in accordance with embodiments of the present disclosure.

FIG. 10D is a front view of a lift system in a raised position in accordance with embodiments of the present disclosure.

FIG. 10E is a front view of a lift system in a lowered position in accordance with embodiments of the present disclosure.

FIG. 11A is a top view of a lift system in accordance with embodiments of the present disclosure.

FIG. 11B is a side view of a lift system in a lowered position in accordance with embodiments of the present disclosure.

FIG. 11C is a front view of a lift system in a lowered position in accordance with embodiments of the present disclosure.

FIG. 12A is a perspective view of a support structure of a lift platform in accordance with embodiments of the present disclosure.

FIG. 12B is a top view of a support structure of a lift platform in accordance with embodiments of the present disclosure.

FIG. 12C is a front view of a support structure of a lift platform in accordance with embodiments of the present disclosure.

FIG. 12D is a side view of a support structure of a lift platform in accordance with embodiments of the present disclosure.

FIG. 13A is a top view of a support structure of a lift platform having a buoyancy tank in accordance with embodiments of the present disclosure.

FIG. 13B is a front view of a support structure of a lift platform having a buoyancy tank in accordance with embodiments of the present disclosure.

Systems and methods according to present disclosure will now be described more fully with reference to the accompanying drawings, which illustrate various exemplary embodiments. Concepts according to the present disclosure may, however, be embodied in many different forms and should not be construed as being limited by the illustrated embodiments set forth herein. Rather, these embodiments are provided so that this disclosure will be thorough as well as complete and will fully convey the scope of the various concepts to those skilled in the art and the best and preferred modes of practice.

### DETAILED DESCRIPTION

Certain aspects of the present disclosure include systems and methods for launching and recovering vessels and structures in a marine environment. In some embodiments, the systems and methods are configured for launch and recovery of relatively large and heavy marine vessels and equipment, such as offshore wind turbines, foundations thereof, and components thereof. In one particular embodiment, the systems and methods are configured for launch and recovery of foundations (also referred to as “floating wind foundations”) for offshore wind turbines. The floating wind foundations can be semisubmersible floating wind foundations or tension leg platform (TLP) floating wind foundations. While the embodiments shown in the Figures of the present disclosure illustrate the systems and methods used to launch and recover floating wind foundations for offshore wind turbines, the systems and methods disclosed herein are not limited to this particular application and may be used for launch and recovery of other marine vessels and equipment. For example, the systems and methods may be configured for launch and recovery of commercial and military ships, submarines, yachts, or other relatively large and heavy marine vessels and equipment.

### Floating Dock

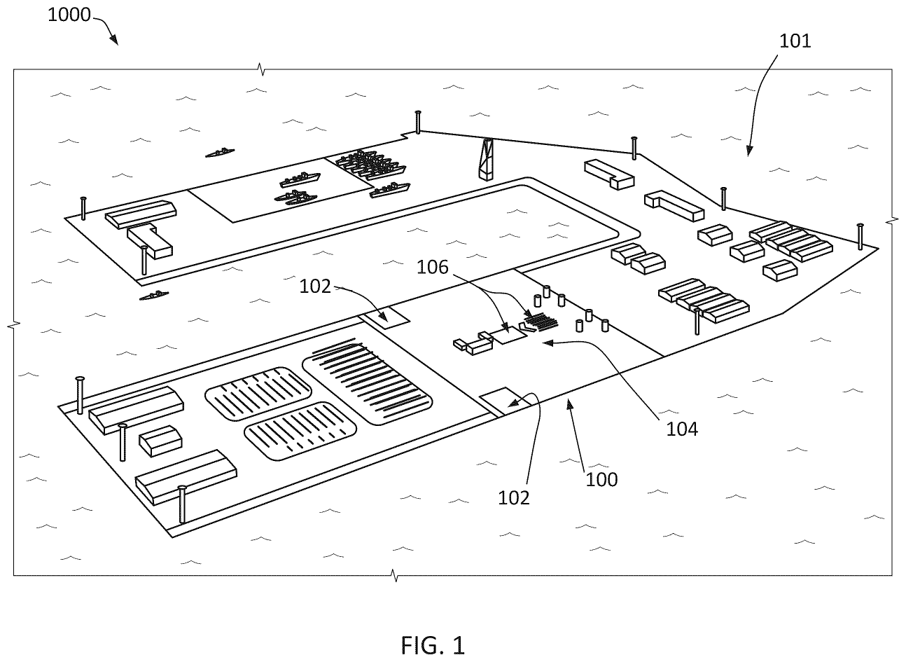

The present disclosure includes floating docks that can be moored at a site, in proximity to a wind farm, for use during the installation, maintenance, and decommissioning of wind farm equipment, including for use as a dry dock for storage of components used for construction and maintenance of wind farms. The operation of an embodiment of a floating dock in the maintenance of a wind farm is illustrated with reference to FIGS. 1-8.

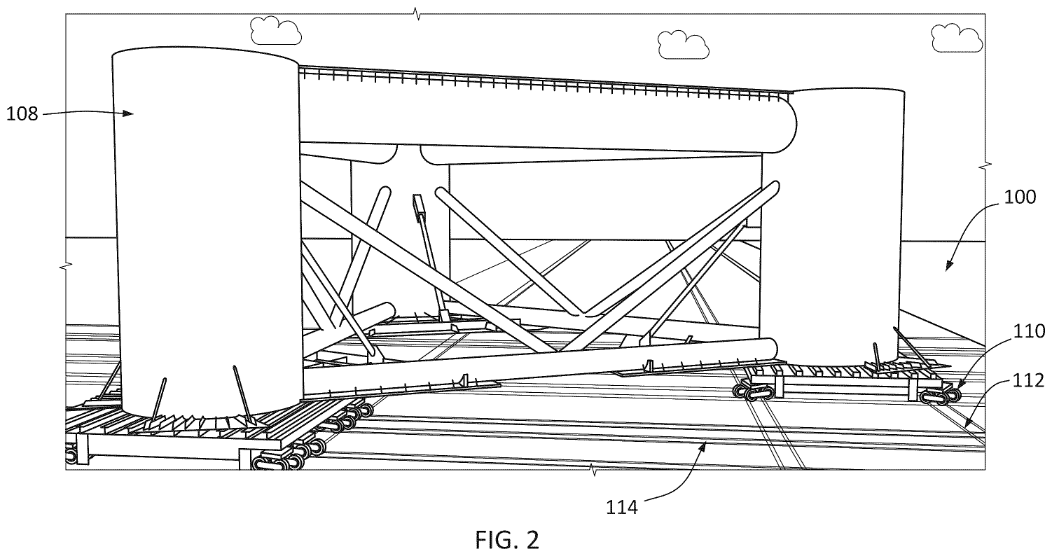

FIG. 1 depicts an exemplary system for assembly, launch, recovery, and maintenance of wind turbines, including floating wind foundations for offshore wind turbines. System 1000 includes dock 100. The dock 100 can be a floating dock that is moored at the site 101. The site 101 can be in proximity to a wind farm, such that the system 1000 is positioned to provide for the ongoing launch and recovery functions related to the installation, maintenance, and decommissioning of the wind farm. The dock 100 also functions as a dry dock for storage of components and tools related to the assembly and maintenance of the components of the wind farm. For example, the dock 100 includes assembly area 104. The assembly area 104 functions, at least in part, as a staging area for floating wind foundation components 106 that are used in the assembly and/or maintenance of floating wind foundations and other components of wind turbines. The components 106 can be assembled together on the dock 100 (e.g., at assembly area 104) to construct a floating wind foundation 108, as shown in FIG. 2, or to construct a fully assembled wind turbine. In some embodiments, the dock 100 is sufficient in size to simultaneously assemble multiple floating wind foundations. While not shown, tower, nacelle and/or blade installation onto the floating wind foundation 108 can also be performed on the dock 100 prior to deployment of the floating wind foundation.

The dock 100 includes two lift platforms 102. The systems disclosed herein are not limited to including two lift platforms, and may include only one lift platform or more than two lift platforms. The lift platforms 102 are used for the launch of wind turbine components (or fully assembled wind turbines), as well as for the recovery of wind turbine components (or fully assembled wind turbines), such as for repair, maintenance, or decommissioning.

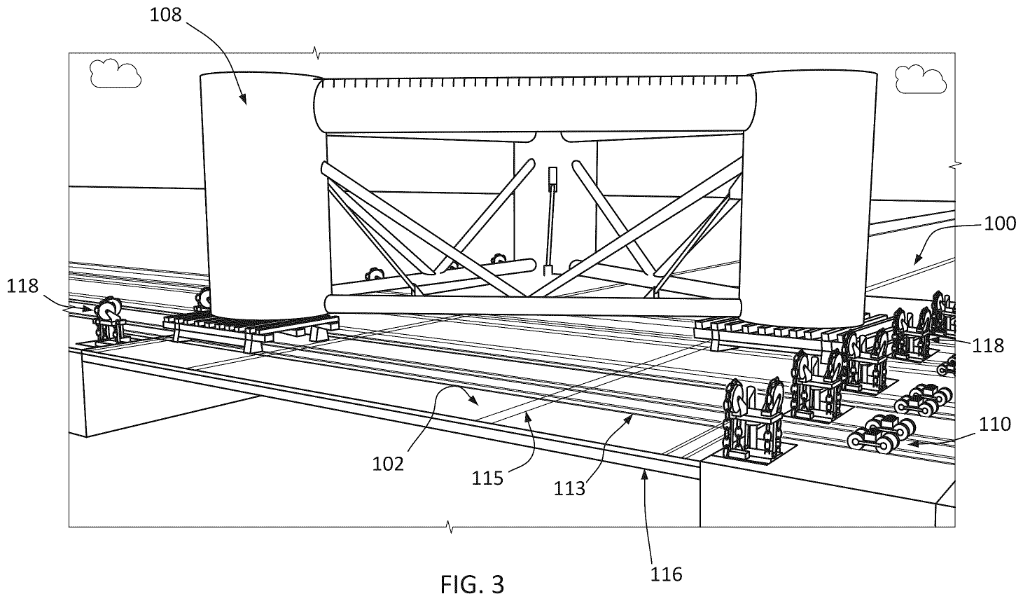

FIGS. 2 and 3 illustrate the transport of an assembled floating wind foundation 108 on the dock 100. After assembly, the floating wind foundation 108 is transported on the dock 100 from the assembly area 104 to one of the lift platforms 102. The floating wind foundation 108 is transferred on the dock 100 via bogies 110 moving on rails 112 and 114 on the dock 100. The lift platforms 102 are positioned adjacent the dock 100 within a space defined, at least partially, by the dock 100. The lift platforms 102 include rails 113 and 115 that align with the rails 112 and 114 on the dock 100, such that the bogies 110 transport the floating wind foundation 108 onto the lift platform 102.

The lift platforms 102 are supported by a plurality of girders 116. The dock 100 includes a plurality of chain jacks 118 positioned along both sides of each lift platform 102. The chain jacks 118 are coupled with the lift platform 102 and configured to raise and lower the lift platform 102 relative to the dock 100. While chain jacks are illustrated, the systems disclosed herein are not limited to chain jacks and may include other lifts or lifting systems capable of raising and lowering the lift platforms. In FIG. 3, the lift platform 102 is shown in a raised position relative to the dock 100.

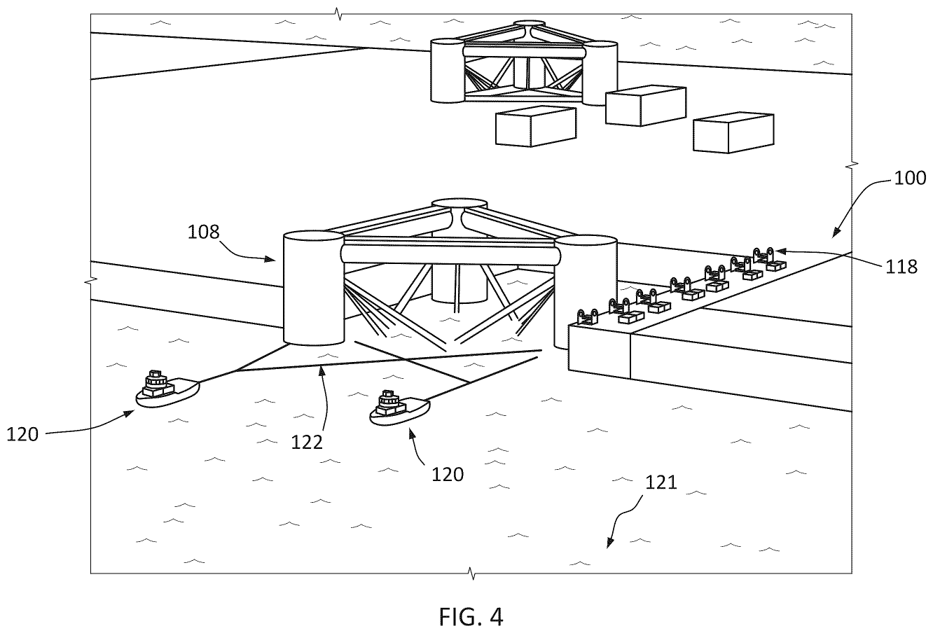

After placement of the floating wind foundation 108 on the lift platform 102, the bogies 110 are disconnected from the floating wind foundation 108 and moved from the lift platform 102 back onto the dock 100. To deploy the floating wind foundation 108, the lift platform 102 is lowered, using the chain jacks 118, from the raised position shown in FIG. 3 to a lowered position as shown in FIG. 4. In FIG. 4, the lift platform 102 is not visible as it is positioned below a level of the water 121. With the floating wind foundation 108 in the water 121, tug boats 120 are tethered to the floating wind foundation 108 via lines 122. The tug boats 120 tow the floating wind foundation 108 from the dock 100 to the desired location, wind farm 126, as shown in FIG. 5. At the wind farm 126 the remaining components (e.g., a tower 125, nacelle 127 and/or blades 129) are assembled onto the floating wind foundation 108 to form a wind turbine 124. In other embodiments, the tower 125, nacelle 127 and/or bladed 129 are already assembled onto the floating wind foundation 108 at the dock 100 and are towed to the wind farm 126. The steps of assembly, transport, and installation of a wind turbine, described in references to FIGS. 1-5, can be repeated to provide the wind farm with the desired number of wind turbines. Furthermore, the assembly, transport, and installation of a wind turbine is not limited to the particular steps or order of steps as shown in FIGS. 1-5. One skilled in the art would understand that some steps may be eliminated, added, or combined, and that the order of the steps may be modified.

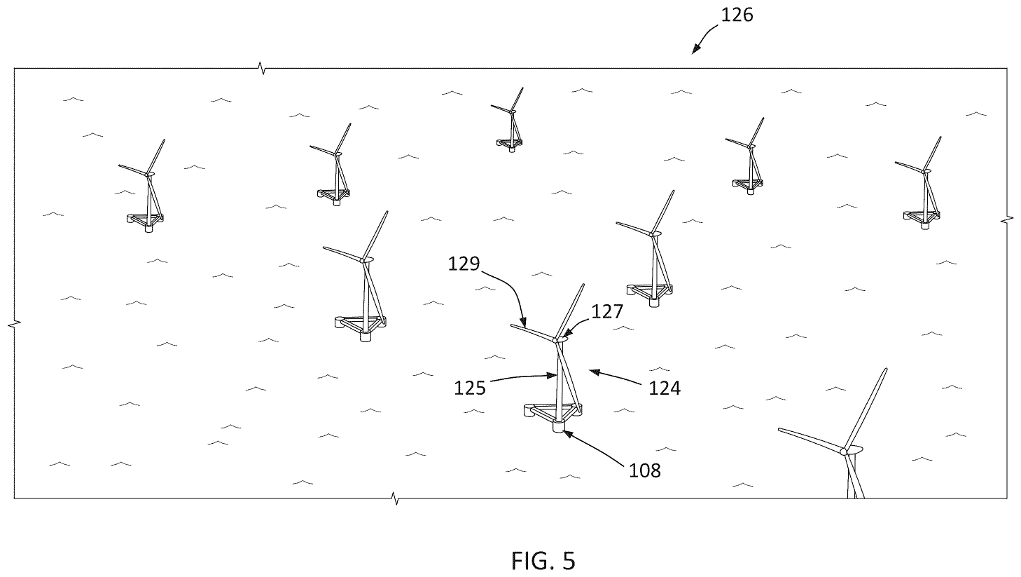

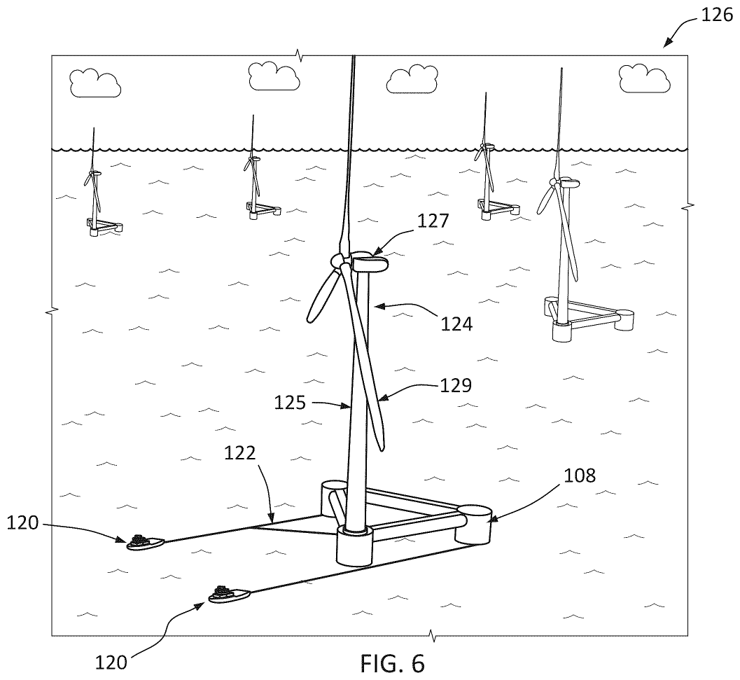

With the wind farm installed, as illustrated in FIGS. 1-5, the system 1000 can remain in place for ongoing maintenance of the wind farm 126, as well as for decommissioning of the wind farm 126. That is, the dock 100 can remain moored at the site 101 in proximity to the wind farm 126. The dock 100 can function as both a dry dock storing components for repair of the wind turbines 124, as well as a work site for repair and maintenance operations to be performed. With reference to FIG. 6, when a wind turbine 124 of the wind farm 126 requires maintenance, repair, or decommissioning, tub boats 120 can be tethered to the wind turbine 124 via lines 122 for towing of the wind turbine 124 back to the dock 100 for the maintenance, repair, or decommissioning. While FIG. 6 shows a fully assembled wind turbine 124 being towed back to the dock 100, in other embodiments, less than an entirety of the wind turbine 124 may be in need of maintenance, repair, or decommissioning, such that only those components (e.g., the blades 129) requiring maintenance, repair, or decommissioning are towed back to the dock 100.

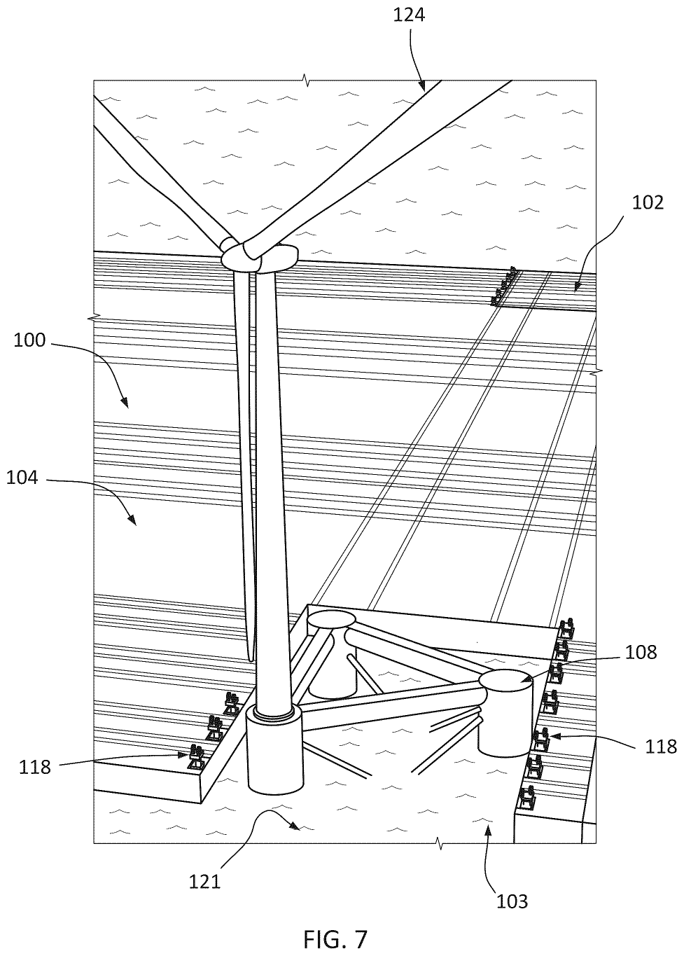

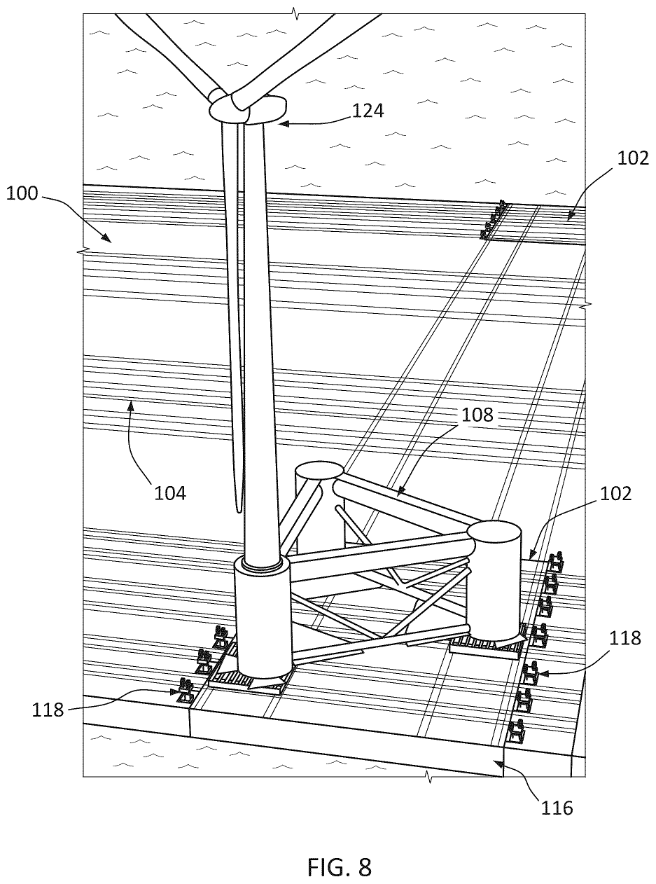

The tub boats 120 transport the wind turbine 124 from the wind farm 126 and into the space 103 of the dock 100 where the lift platform 102 is positioned. In FIG. 7, the lift platform is not visible in the space 103 as it is positioned below a level of the water 121. The wind turbine 124 is positioned above the lift platform 102. With the wind turbine 124 positioned above the lift platform 102, the lift platform 102 is raised by the chain jacks 118 from the lowered position shown in FIG. 7 to the raised position shown in FIG. 8. The wind turbine 124 can then moved on the rails of the lift platform 102 and dock 100 to the assembly area 104 or another area on the dock 100 for repair, maintenance, and/or disassembly (e.g., in the case of decommissioning). After repair or maintenance is performed, the wind turbine 124 can be transported back to the wind farm for installation in the same or similar manner as described with reference to FIGS. 1-5. If the wind turbine 124 is decommissioned, then a replacement wind turbine can be transported to the wind farm 126 for installation.

### Lift Platform

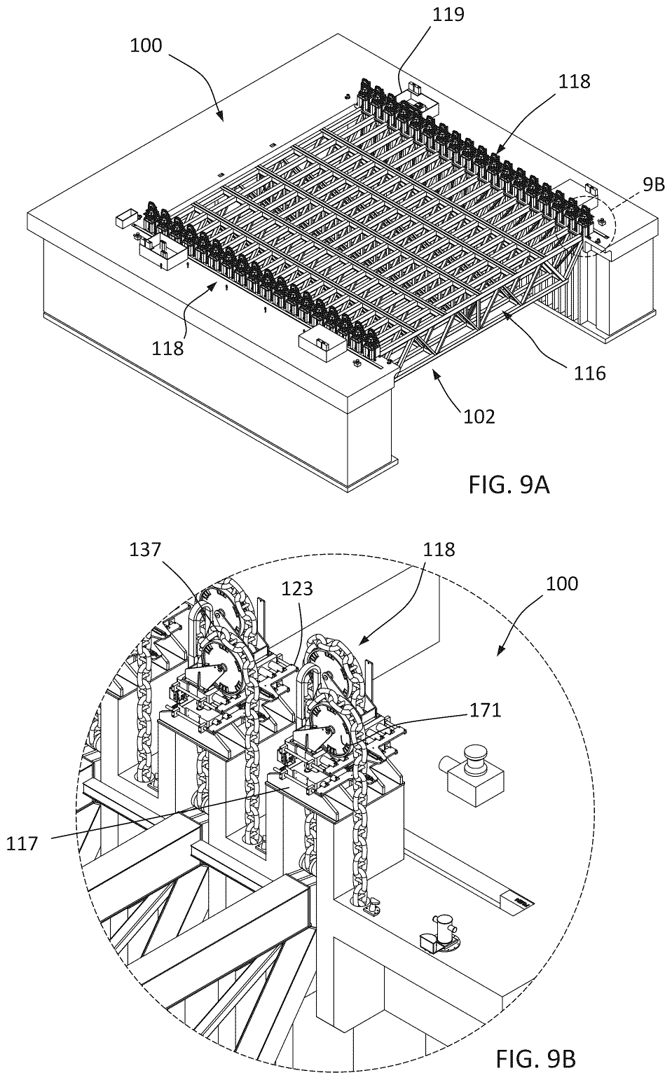

The lift platforms disclosed herein are configured for lifting and lowering of floating wind foundations and fully assembled wind turbines. The lift platforms have spans that are sufficiently sized to fit floating wind foundations and fully assembled wind turbines, and the platforms are sufficiently supported by girders capable of supporting the weight of floating wind foundations and fully assembled wind turbines. The lift platforms and components thereof are shown and described in more detail with reference to FIGS. 9A-12D.

FIG. 9A depicts lift platform 102 installed on dock 100 with a plurality of chain jacks 118 arranged along the lateral side edges of the lift platform 102, and FIG. 9B is a detail view of a portion of FIG. 9A. In FIGS. 9A and 9B, the top platform of the lift platform 102 is not shown, revealing the underling plurality of girders 116 that support the top platform.

Each chain jack 118 includes a jack 123 (e.g., a cylinder jack) coupled with a chain 137 and a support structure 117 to support the components of the chain jack 118 on the dock 100. The chain 137 is coupled with the jack 123 and with the lift platform 102, and is engaged on a chainwheel 171. When actuated, the jack 123 lets out the chain 137 to lower the lift platform 102 or hauls in the chain 137 to lift the lift platform 102. The actuation of the plurality of chain jacks 118, to raise or lower the lift platform, can be controlled by a hydraulic power unit 119 on the dock 100. The plurality of the chain jacks 118 can be operated synchronously. In some embodiments, the operation of the chain jacks 118 to raise and lower the lift platform 102 is the same or substantially the same as the operation of the chain jacks to raise and lower the shiplift platforms as is described in U.S. patent application Ser. No. 15/817,876 (the '876 application), the entirety of which is incorporated herein by reference. The lift platforms 102 and chain jacks 118 disclosed herein are capable of raising and lowering floating wind foundations and wind turbines for wet tow, dry dock, repair, maintenance, and/or replacement, such as to extend the life of the floating wind foundation and associated wind turbines.

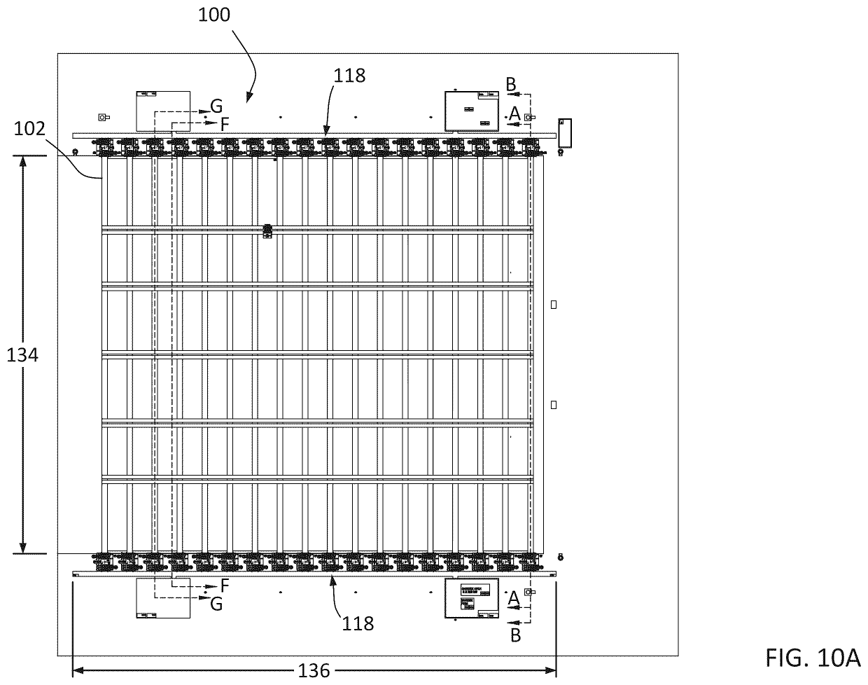

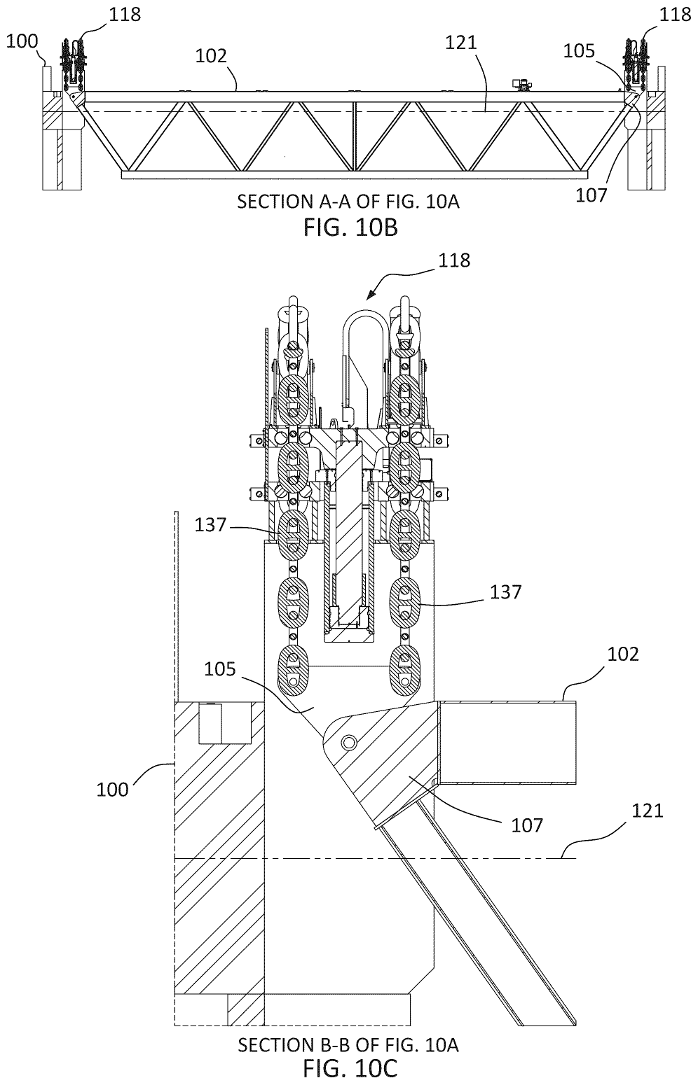

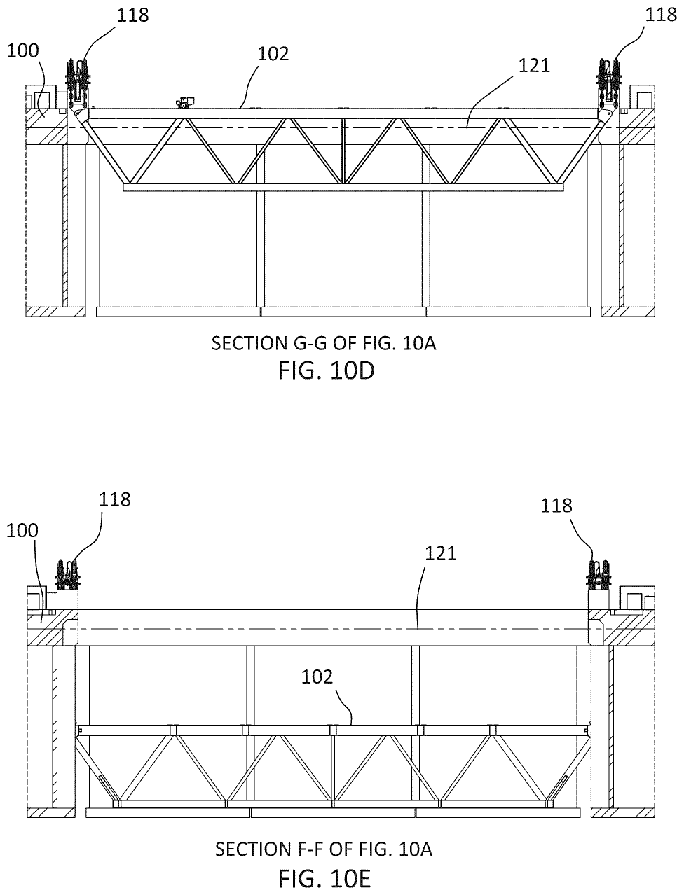

FIG. 10A is a top view of the dock 100 with the lift platform 102 and a plurality of chain jacks 118. FIGS. 10B and 10C show the lift platform 102 in the raised position above the level of water 121. The chains 137 of each chain jack 118 are coupled with the lift platform 102. In the embodiment shown in FIGS. 10B and 10C, each chain 137 is coupled with a chain plate 105, and each chain plate 105 is coupled (e.g., bolted) with a platform plate 107. The platform plate 107 may be coupled with the lift platform 102 or be an integral part of the lift platform 102. With the chains 137 coupled with the lift platform 102, the chain jacks 118 can be actuated to raise and lower the lift platform 102 relative to the level of the water 121.

The lift platform 102 has a width span 134 and a length span 136 that is of sufficient size to accommodate floating wind foundations and wind turbines. In some embodiments, the top surface of the lift platform 102 has a square-shaped top surface to accommodate floating wind foundations for wind turbines that have triangular cross-sections. The top surface of the lift platforms disclosed herein are not limited to having square-shaped top surfaces. In some embodiments, the width span 134 ranges from 60 meters to 120 meters, or from 70 meters to 105 meters, or any range or discrete value therebetween. In some embodiments, the length span 136 ranges from 60 meters to 120 meters, or from 70 meters to 105 meters, or any range or discrete value therebetween. The width span 134 may be equal to, greater than, or less than the length span 136. The width span 134 and length span are at least 60 meters, or at least 70 meters.

FIG. 10D is a cross-sectional view showing the lift platform 102 in the raised position with a top of the lift platform 102 positioned above the level of the water 121. FIG. 10E is a cross-sectional view of the lift platform 102 identical to FIG. 10D, but showing the lift platform 102 in the lowered position with a top of the lift platform positioned below the level of the water 121.

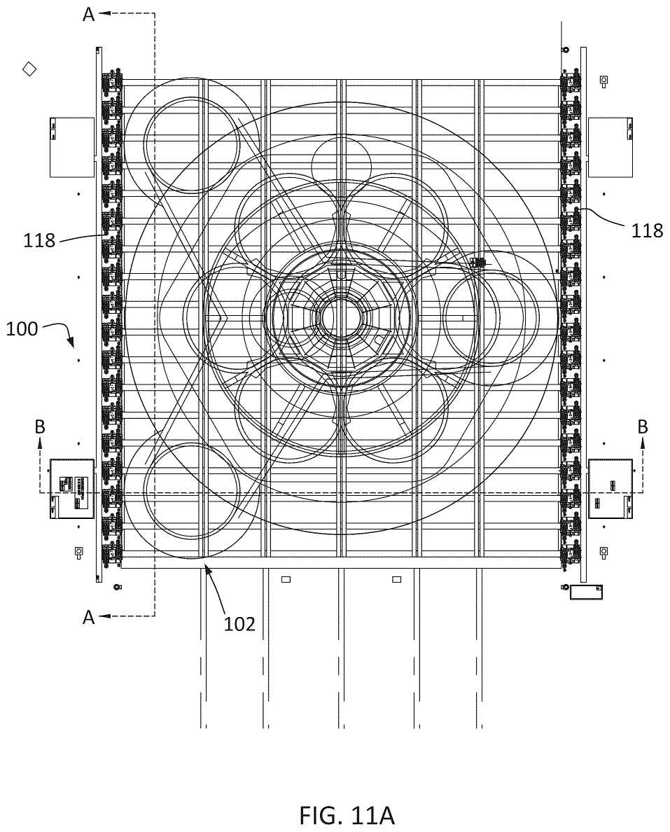

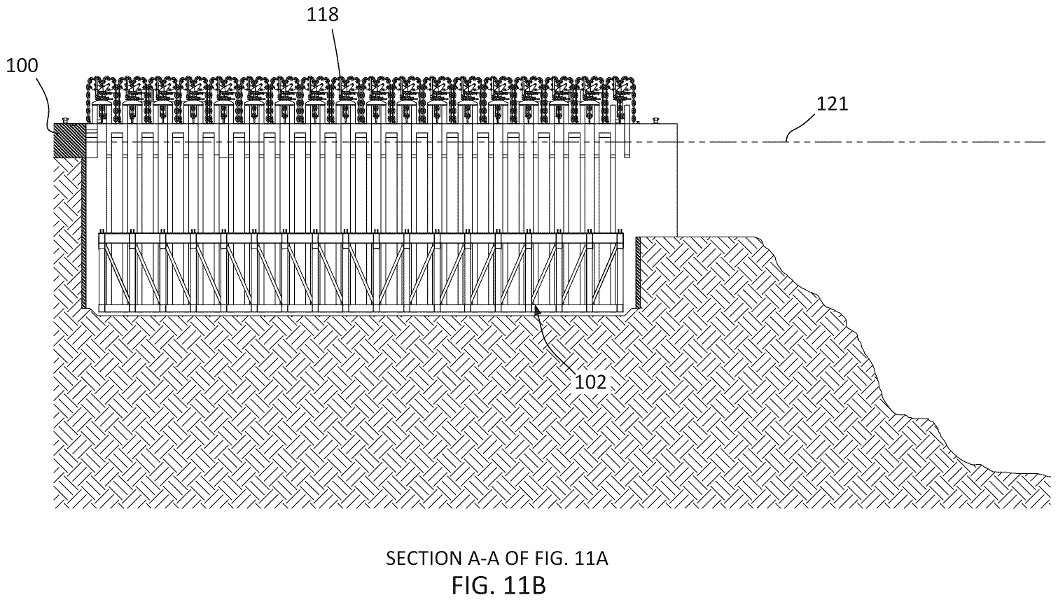

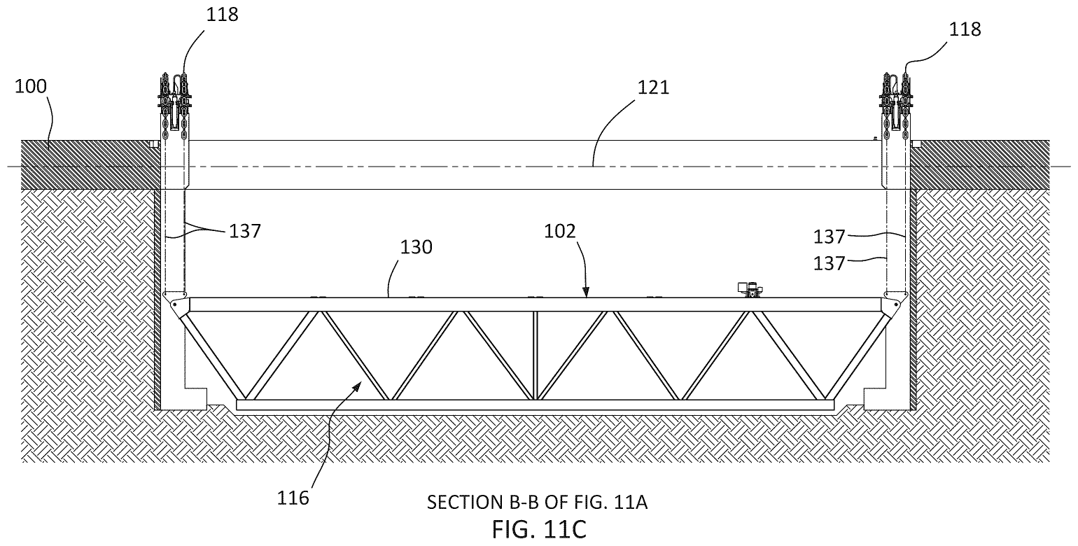

FIG. 11A is a top view of the lift platform 102, and FIGS. 11B and 11C are cross-sectional views of the lift platform. FIGS. 11A-11C show the lift platform 102 in the lowered position, below the level of the water 121. Lift platform 102 includes top platform 130 (also referred to as upper deck) supported by a plurality of girders 116. The top platform 130 is configured to receive floating wind foundations and fully assembled wind turbines. The girders 116 are positioned beneath the top platform 130.

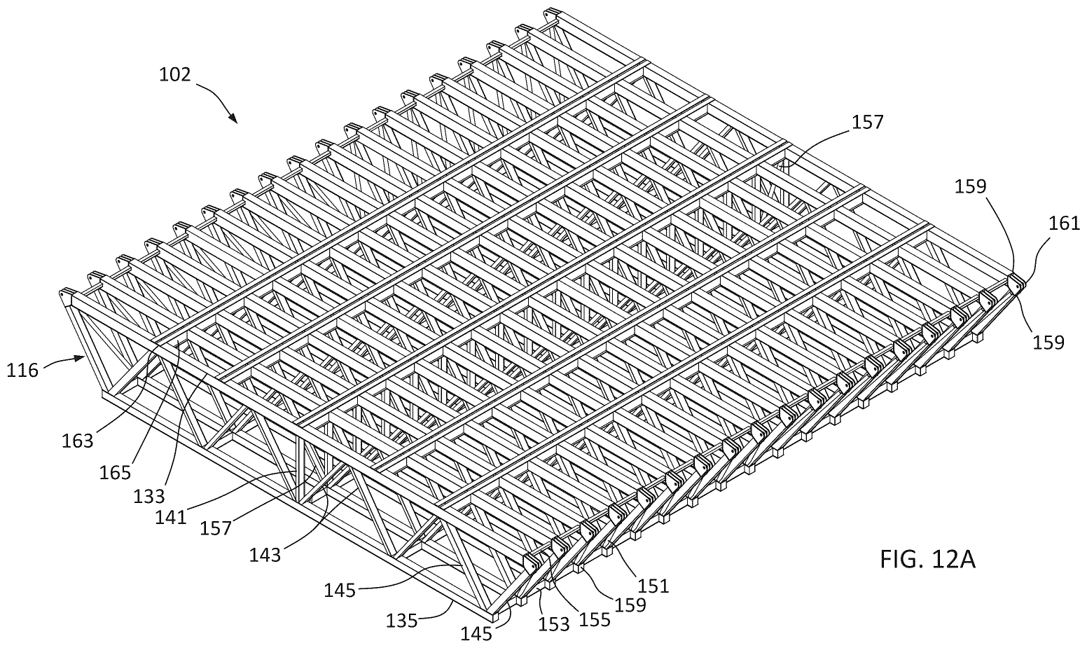

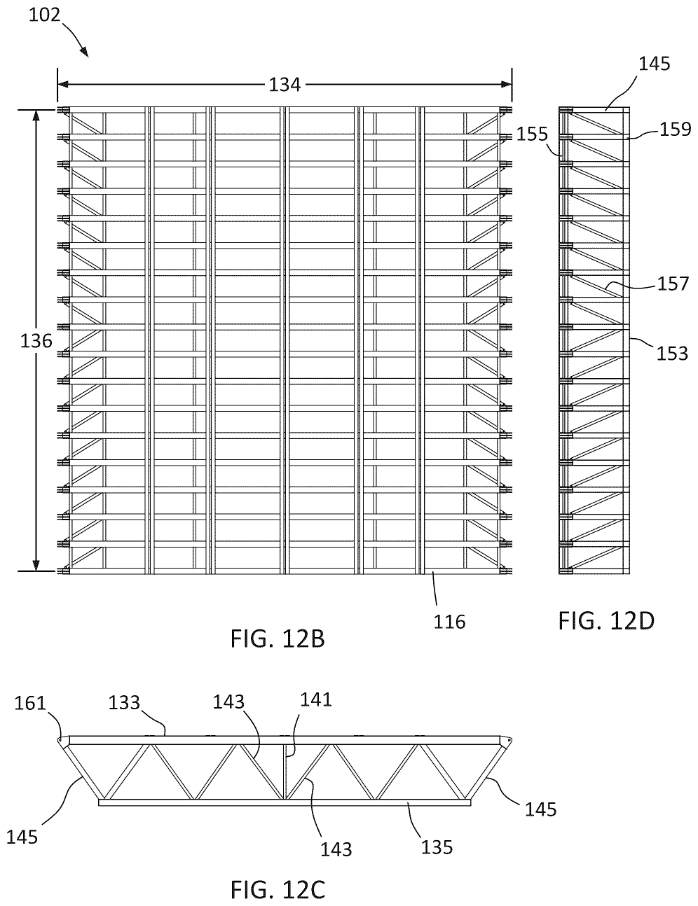

FIG. 12A depicts the support structure of the lift platform 102 in isolation from the dock and chain jacks. FIG. 12B is a top view of the support structure of FIG. 12A, and FIGS. 12C and 12D are front and side views of FIG. 12B. The lift platform 102 includes a plurality of girders 116. Each girder 116 includes a lower chord (truss) 135 and top chord (truss) 133. Extending between and connecting the lower chord 135 and top chord 133 are a plurality of members that form a web, including inner vertical web truss 141, inner diagonal web trusses 143, outer diagonal web trusses 145, and outer diagonal bracing 151. The support structure of the lift platform also includes lower chord bracing 153, top chord bracing 155, inner truss diagonal bracing 157, cap plats 159, knuckle clevis 161 (serving as the platform plate), and runway 163 and runway girder 165. The girders disclosed herein are not limited to the particular shape and configuration shown in the drawings. The girders 116 can be in the form of box truss girders capable of spanning the width span and supporting the load of a floating wind foundation, with or without the remaining components of the wind turbine attached thereto. The girders 116 are made of a material capable of supporting the load of the floating wind foundations and wind turbines at such width spans. For example, and without limitation, the girders 116 can be made of steel. In some embodiments, the components of the support structure of the lift platform 102 are coupled together such that the support structure of the lift platform 102 forms a unitary structure capable of supporting the lift platform 102 and any load thereon.

### Buoyancy Tanks

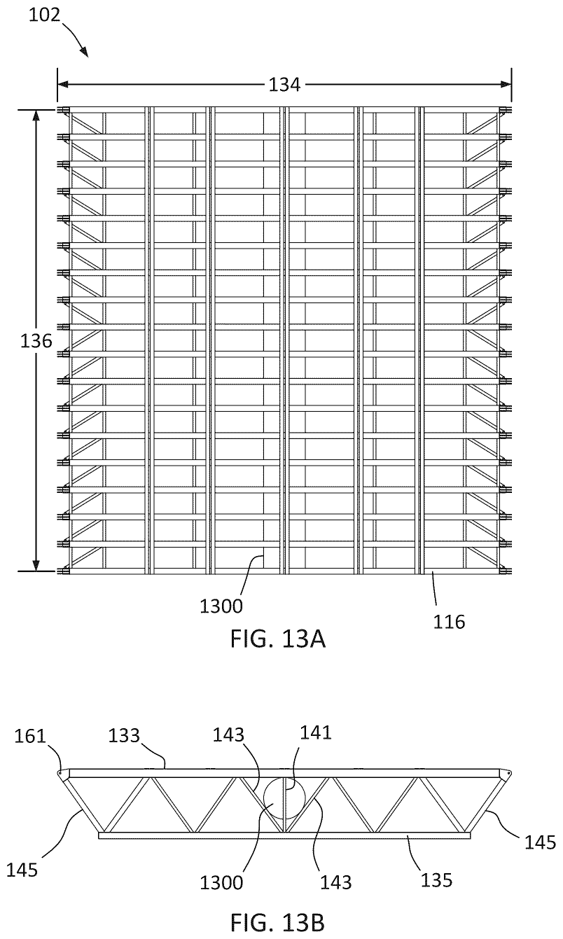

In some embodiments, one or more buoyancy tanks are incorporated into the lift platform. With reference to FIGS. 13A and 13B an embodiment of the lift platform including a buoyancy tank is shown. Lift platform 102 is identical to the one shown in FIGS. 12B and 12C with the exception that a buoyancy tank 1300 is incorporated into the lift platform 102. The buoyancy tank 1300 (e.g., floatation tank) in attached to or otherwise incorporated into the support structure of the lift platform 102. The buoyancy tank 1300 is configured to provide the lift platform 102 with a negative buoyancy. By providing the lift platform 102 with a negative buoyancy, the depth of the truss structure of the lift platform can reduced; thereby, reducing the excavation depth that is required for installation of the lift platform at the site. This reduction in excavation can reduce the cost of installing the lift platform by saving dredging and excavation costs. The incorporation of the buoyancy tank 1300 can, in some embodiments, improve the efficiency of the lift system by from 17% to 20%. In some embodiments, as shown in FIGS. 13A and 13B, the buoyancy tank 1300 is positioned along a center axis of the lift platform 102. With the buoyancy tank 1300 positioned along the center axis of the lift platform 102, the buoyancy tank 1300 offsets dead load of the lift platform 102 and reduces the depth the truss (girders 116) required to support any payload on the span of the lift platform 102. While shown as including a single buoyancy tank, the lift platforms disclosed herein can include more than one buoyancy tank. While the buoyancy tank is shown along the central axis of the lift platform, in other embodiments, the lift platform includes buoyancy tanks posited at other locations on the lift platform.

### Applications

As the dock is a floating dock that is moored at the site, the services provided at the dock can be integrated into a port without sacrificing valuable laydown area, supporting industrialization and operational efficiencies. The dock can operate as a drydock that is positioned in close geographic proximity to the wind farm to provide for deployment, retrieval and maintenance of that wind farm. As services are routinely needed for wind farms, the close proximity of the present system reduced the time, cost, and environmental impacts (e.g., emissions can be reduced by shortening travel distances for maintenance) to of providing such services.

The lift systems disclosed herein provide for a relatively simple, safe, and controlled solution to the assembly, deployment, and retrieval of floating wind foundations. For example, embodiments of the present systems are subject to less health, safety, and environmental (HSE) variables in comparison to methods that use a semi-submersible barge, such as wave height and quayside mooring. Embodiments of the present system do not require ballasting operations to support load-out, do not require offshore tugs for stability, and are tide independent. In some embodiments, the system disclosed herein can lower a floating wind foundation for wet storage in about an hour, without being limited by status of the tides or weather conditions. Additionally, the usefulness of the system does not end with deployment, as the system can remain in place for ongoing maintenance of the wind farm and vessels operating in the region.

The ability to assemble, deploy, retrieve, repair, and replace floating wind foundations and wind turbines on the systems disclosed herein can improve and streamline the supply chain process for such structures. The assembly process can be configured for serial production of floating wind foundations. In some embodiments, the system includes an integrated extension to an existing quayside including an additional assembly area. The systems disclosed herein provide for the assembly of large floating offshore wind platforms, such as semisubmersibles and TLPs, on a stable surface of the dock. After assembly, the assembled structures can be directly lowered for wet tow, reducing health and safety risks in comparison to methods that involve floating such assembled structures.

The systems disclosed herein can also reduce or eliminate bottlenecks resulting from supply chain issues, such as the need for large ringer cranes that are of limited global availability. For example, alternative lifting devices, such as stiff leg derrick cranes, are less costly, more straightforward, and quicker to construct, maintain, and operate than large ringer cranes. Thus, the present systems can reduce risk to projects arising from both supply chain issues and safety-related issues.

It is clear from the foregoing that embodiments of the present system and method can provide for various benefits relative to current technologies including, but not limited to, a reduction of CO₂ footprint, a streamlined assembly process for serial production, accommodation for a variety of hull designs, elimination of ballast water pollution, elimination of contaminants in water form hull build out, and elimination of the need for tide-dependent submersibles to load out and float.

While the systems and methods are described in relation to assembly, deployment, retrieval, and maintenance of floating wind foundations, the systems and methods are not limited to this application and may be used to assemble, deploy, retrieve, and/or maintain other marine structures.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A floating lift system for launch and recovery of marine equipment, the floating lift system comprising:
a lift platform, wherein the lift platform has a width of at least sixty meters and a length of at least sixty meters, and wherein the lift platform comprises an upper deck supported by a plurality of girders;
a plurality of lifts, wherein the lifts are coupled with the lift platform and configured to raise and lower the lift platform.

2-18. (canceled)

19. A method of deploying and retrieving marine equipment, the method comprising:
positioning marine equipment on a lift platform of a floating lift system, wherein the lift platform has a width of at least sixty meters and a length of at least sixty meters, and wherein the lift platform comprises an upper deck supported by a plurality of girders;
raising the lift platform with a plurality of lifts to retrieve the marine equipment, or lowering the lift platform with the plurality of lifts to deploy the marine equipment.

20-22. (canceled)

23. The method of claim 19, further comprising providing a buoyancy to the lift platform to offset dead load of the lift platform.

24. (canceled)

25. A floating dock system for deploying and retrieving marine equipment, the floating dock system comprising:
a floating dock;
a plurality of lifts on the floating dock;
a lift platform positioned adjacent the floating dock, wherein the lift platform comprises an upper deck supported by a plurality of girders;
wherein the lifts are coupled with the lift platform and configured to raise and lower the lift platform relative to the floating dock.

26. The floating dock system of claim 25, wherein the girders extend across an entirety of the width of the lift platform.

27. The floating dock system of claim 25, wherein the lift platform has a shape and size configured to accommodate foundations of wind turbines.

28. The floating dock system of claim 25, wherein the length and width of the lift platform are equal such that the upper deck has a square shape.

29. The floating dock system of claim 25, comprising two lift platforms, wherein each lift platform is coupled with a plurality of lifts on the floating dock.

30. The floating dock system of claim 25, wherein the width of the upper deck ranges from sixty meters to one hundred twenty meters, and wherein the length of the upper deck ranges from sixty meters to one hundred twenty meters.

31. (canceled)

32. The floating dock system of claim 25, wherein the girders comprise box truss girders.

33. (canceled)

34. The floating dock system of claim 25, further comprising a buoyancy tank coupled with the lift platform.

35. The floating dock system of claim 34, wherein the buoyancy tank is configured to provide the lift platform with buoyancy.

36. The floating dock system of claim 25, wherein the buoyancy tank is positioned along a central axis of the lift platform.

37. The floating dock system of claim 25, wherein the buoyancy tank offsets dead load of the lift platform.

38. The floating dock system of claim 25, wherein the lifts are positioned on the floating dock along two sides of the lift platform.

39. The floating dock system of claim 25, wherein the lifts comprise chain jacks.

40. The floating dock system of claim 39, wherein each chain jack includes a chain on a chainwheel and a cylinder jack coupled with the chain, wherein the chain is coupled with the lift platform, and wherein the cylinder jack is actuable to release the chain to lower the lift platform or haul-in the chain to raise the lift platform.

41. The floating dock system of claim 40, further comprising a hydraulic power unit on the floating dock, wherein the hydraulic power unit is coupled with the chain jacks and configured to actuate the cylinder jacks.

42. The floating dock system of claim 40, further comprising one or more plates coupled between the chain and the lift platform.

43. The floating dock system of claim 25, wherein the lifts are configured to raise and lower the lift platform between a first height above a water level and a second height below the water level.

44. The floating dock system of claim 25, wherein the floating dock at least partially defines a space, and wherein the lift platform is positioned at least partially within the space.

45. The floating dock system of claim 25, wherein the floating dock is moored at a site.

46. The floating dock system of claim 45, wherein the site is in proximity to a wind farm.

47. The floating dock system of claim 25, wherein the floating dock comprises a dry dock space for storage of components of marine equipment and an assembly area for assembly of marine equipment.

48. The floating dock system of claim 47, wherein the marine equipment comprises foundations, towers, nacelles, and blades for offshore wind turbines.

49. The floating dock system of claim 25, further comprising a plurality of rails on the floating dock and the lift platform, and a plurality of bogies for transport of marine equipment along the rails on the floating dock and lift platform.

50. A wind farm system, the system comprising:
a wind farm positioned at a first offshore site, the wind farm comprises a plurality of offshore wind turbines;
a floating dock moored at a second offshore site, wherein the second offshore site is in close proximity to the first offshore site;
a plurality of lifts on the floating dock;
a lift platform positioned adjacent the floating dock, wherein the lift platform comprises an upper deck supported by a plurality of girders;
wherein the lifts are coupled with the lift platform and configured to raise and lower the lift platform relative to the floating dock.

51. The system of claim 50, further comprising one or more tug boats configured for transport of wind turbines or components thereof between the first and second offshore sites.

52. (canceled)

53. A method of assembling, maintaining, and decommissioning a wind farm, the method comprising:
mooring a floating dock at a first offshore site;
assembling an offshore wind turbine or components thereof on the floating dock;
deploying the offshore wind turbine or components thereof into water at the first offshore site, wherein the deploying comprises positioning the offshore wind turbine or components thereof on a lift platform of the floating dock and lowering the lift platform into the water; and
transporting the offshore wind turbine or components thereof from the first offshore site to a second offshore site and installing the offshore wind turbine or components thereof at the second offshore site to form a wind farm at the second offshore site.

54. The method of claim 53, further comprising:
retrieving an offshore wind turbine or components thereof from the second offshore site;
transporting the offshore wind turbine or components thereof from the second offshore site to the first offshore site;
retrieving the offshore wind turbine or components thereof from the water at the first offshore site, wherein the retrieving comprises positioning the offshore wind turbine or components thereof on the lift platform and raising the lift platform out of the water; and
repairing, maintaining, or decommissioning the offshore wind turbine or components thereof.

55. The method of claim 53, wherein the assembling comprises assembling a foundation of an offshore wind turbine.

56. The method of claim 55, wherein the assembling comprises assembling a tower, nacelle, and blades onto the foundation.

57. The method of claim 53, wherein the transporting comprises towing using one or more tug boats.

58. (canceled)

59. The floating dock system of claim 25, further comprising multiple buoyancy tanks coupled with the lift platform.
